(19) United States
(12) Patent Application Publication
(10) Pub. No.: US 2006/0106635 A1
(43) Pub. Date: May 18, 2006

(54) Emission remediation

(76) Inventors: Karl Ulrich, Narberth, PA (US); George Favaloro, Lincoln, MA (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 11/281,851

(22) Filed: Nov. 17, 2005

Related U.S. Application Data
(60) Provisional application No. 60/628,922, filed on Nov. 18, 2004.

(51) Int. Cl. G06Q 99/00

(52) U.S. Cl. 705/1

(57) ABSTRACT

An emission remediation system and methods are disclosed. An emission remediation indicator associated with an emission-related activity is vended. At least a portion of proceeds from the vending of remediation indicators is aggregated into a fund. A remediation activity by an emission producer is funded using the aggregate fund.

### REFERENCE TO RELATED APPLICATIONS

This application claims priority to U.S. Provisional Application 60/628,922, filed Nov. 18, 2004, which is herein incorporated by reference.

### BACKGROUND OF THE INVENTION

Many individuals, businesses, organizations, and governments are interested in finding ways to reduce polluting emissions, such as greenhouse gas emissions. However strong the individual interest, with current practices, it is difficult to make a meaningful reduction in harmful emissions as an individual person, business, organization, or government. For example, it is difficult on an individual basis to significantly reduce the harmful gas emissions that result from ordinary and necessary activities, such as driving, riding public transportation, mowing the lawn, or boating. It is even harder to reduce harmful gas emissions associated with flying on a commercial flight, shipping a package, or those involved in the production or disposal of a manufactured good. With current practices, it is difficult, at best, to aggregate disjointed individual efforts aimed at reducing emissions.

In contrast, most energy utilities and corporate energy producers generally have the ability to adjust the type of fuel they use from more-polluting to less-polluting sources. These entities will make their fuel selections based on meeting required emissions regulations, and then optimizing their fuel selection for cost efficiency. In this context, these entities will generally use the lowest cost fuel without regard for the fuel's polluting effects. In most cases, these entities have no incentive to reduce greenhouse gas emissions beyond the minimal level prescribed by the regulations. Regardless of incentive, these entities are best positioned to shift to lower polluting methods at a relatively low incremental cost, and might consider doing so if it is in their economic interest.

While consumers may be concerned about global warming and may have a strong professed appetite for reducing pollution, they have very limited options to mitigate the greenhouse gas production associated with their ordinary and necessary daily activities. For example, driving, which causes a substantial fraction of the greenhouse gas production in developed countries is a clear necessity for most individuals and families. By some estimates, the average automobile generates about 13,500 pounds of carbon dioxide (CO₂) emissions per year. Families may reduce their driving emissions by shifting to more fuel efficient, less polluting cars which may have a meaningful impact. However, completely eliminating greenhouse gas emissions generally is prohibitively expensive and difficult to accomplish by disjoined individual efforts.

It is also problematic that many of the actions that can be performed to reduce greenhouse gas emissions by individuals are invisible to the community. With current practices, the costs of reducing greenhouse gas emissions generally fall on the individual. However, the benefits of reductions in greenhouse gas emissions accrue to the public at large. Individuals would have more incentive to remediate their emissions if they could get public credit for the remediation they are funding.

One method that has been effective in the industrial sector is the use of offsets or emissions trading. For example, the United States Environmental Protection Agency (U.S. E.P.A.) has developed a program to address sulfur dioxide (SO₂) emissions from electric power plants. In this program, power plant operators who find it a burden to reduce sulfur emissions may, at a relatively low cost, buy allowances from other power plant operators that make extraordinary cuts. As such, a buyer (e.g., non-compliant power plant operator) pays a seller (e.g., over-compliant power plant operator) to reduce the seller's emissions, and the net effect to the environment is as if the buyer reduced its own emissions. With such programs, the average reduction in emissions by participating power plant operators on the whole falls below a selected set threshold.

However, such offset/trading programs are generally developed and targeted to entities having large pollution capability. Consequently, until the present invention there has remained a need for efficient mechanisms that implement emission reduction offsets at the scale of individual members of the general public to promote overall reductions in polluting emissions and provide a socially recognizable credit for those who engage in reducing such emissions.

### SUMMARY

Polluting emission reducing systems and methods are provided. In an illustrative implementation, an emission remediation method comprises vending an polluting emission remediation indicator associated with an emission-related activity, such as the production of harmful greenhouse gases. In an illustrative implementation, at least a portion of proceeds from the vending of remediation indicators is aggregated into a fund. In the illustrative implementation, a remediation activity by an emission producer is funded using the fund.

In an illustrative operation, the fund generated from remediation indicator vending proceeds may be doled out to participating remediation clients to fund one or more selected remediation activities. In the illustrative operation, a remediation indicator vendor may receive funds from a participating remediation indicator client that, in the illustrative operation, may be used to fund one or more remediation activities. In the illustrative operation, the remediation indicator may be displayed by the participating remediation indicator client. Moreover, as illustrated, the remediation indicator may have a price based at least upon a cost for remediating a quantity of emissions associated with the emission-related activity.

Additional objects, advantages and novel features of the invention will be set forth in part in the description, examples and figures which follow, and in part will become apparent to those skilled in the art on examination of the following, or may be learned by practice of the invention.

### BRIEF DESCRIPTION OF THE DRAWINGS

For the purpose of illustrating the herein described emission remediation systems and methods, drawings are provided with the understanding, however, that the herein described system and methods are not limited to the precise arrangements and instrumentalities shown.

FIG. 1 is a diagram of relationships between entities in accordance with the present invention.

FIG. 2 depicts an exemplary implementation of an emission remediation.

FIGS. 3A and 3B show illustrative implementations of a remediation indicator. FIG. 3A shows a first illustrative implementation. FIG. 3B shows a second illustrative implementation.

FIG. 4 is a flow chart showing a method for emission remediation.

### DETAILED DESCRIPTION

Overview

Using aspects of the herein described systems and methods, commercial emission remediation transactions allow clients, such as consumers of energy based goods or services, to effectively eliminate or at least reduce the environmental impact of activities that produce polluting emissions, such as driving a car or traveling. For example, a client may purchase an emission remediation indicator, and thereby cause at least offset the carbon dioxide that results from a given specific activity. In exchange for the purchase price, the client is supplied with an emission remediation indicator that may be placed in public view. This indicates to the public that the client has remediated, in whole or in part, the emissions associated with a polluting activity, including harmful greenhouse gas emissions. As the term “client” is used herein, it is meant to encompass all customers, consumers, purchasers and the like that may use the vended emission remediation indicator, further including individuals, groups of individuals and large or small business entities, such as companies and businesses.

The proceeds from the client's purchase price for the remediation indicator may be applied, according to aspects of the present invention, to advance the use of less-polluting sources of energy and directly or indirectly reduce the production of greenhouse gases. In an illustrative implementation, these funds are used to reduce the marginal cost of substituting various less-polluting energy sources for more-polluting energy sources. For example, energy derived from wind power or natural gas may be substituted for energy derived from coal. Funds generated from such emission remediation transactions may be aggregated as part of a larger remediation effort resulting in remediation activities that substantially offset polluting emissions, such as greenhouse gas production.

Aspects of the herein described systems and methods allow clients, including individual consumers, groups, and/or business entities, to meaningfully reduce greenhouse gas emissions. Aspects of the herein described system and methods provide the ability to bring the demand by the clients for such reductions together with the potential supply of reductions available from the emission producers. Significant reductions in overall polluting emissions, such as greenhouse gas emissions may, are thus achieved by using aspects of the herein described system and methods to cause reductions to be utilized by larger-scale emission producers, such as energy utilities and other energy producers.

In an illustrative implementation, the herein described system and methods ameliorate the shortcomings of existing practices by providing a mechanism by which clients purchase emission remediation credits for their efforts in remediating polluting emissions, such as greenhouse gas emissions. In the illustrative implementation, this mechanism will cause energy producers to shift their fuel choice to less-polluting fuel or energy sources. For example, such a shift may be facilitated by one or more of the following:

A publicly displayable emission remediation indicator that allows a client to inform third parties of the fact that the client has remediated pollution. In an illustrative implementation, such indicator may allow the client to gain tangible and/or intangible incentives resulting from informing others of the client's pollution remediation (e.g., a pizza shop owner, by displaying the pollution remediation indicator on signs, advertisements, menus, placemats, window stickers, delivery vehicles, and the like, could realize increased business volume from customers who support environmentally friendly businesses);

Mass retail and/or electronic commerce methods to market the emission remediation indicators to clients, including individual consumers, groups, and large and small business entities and organizations;

Aggregation of the purchases to gain efficiencies and overcome the high transaction costs an individual acting alone would face to remediate his or her greenhouse gas production;

Efficient purchase of “offsets,” allowing the purchase of an energy producer's commitment to shift fuel consumption from a more-polluting to a less-polluting energy source.

Third parties may also assist the vendor in marketing the emission remediation indicators and may provide additional related incentives and benefits to the purchasers.

Illustrative Entity Relationships

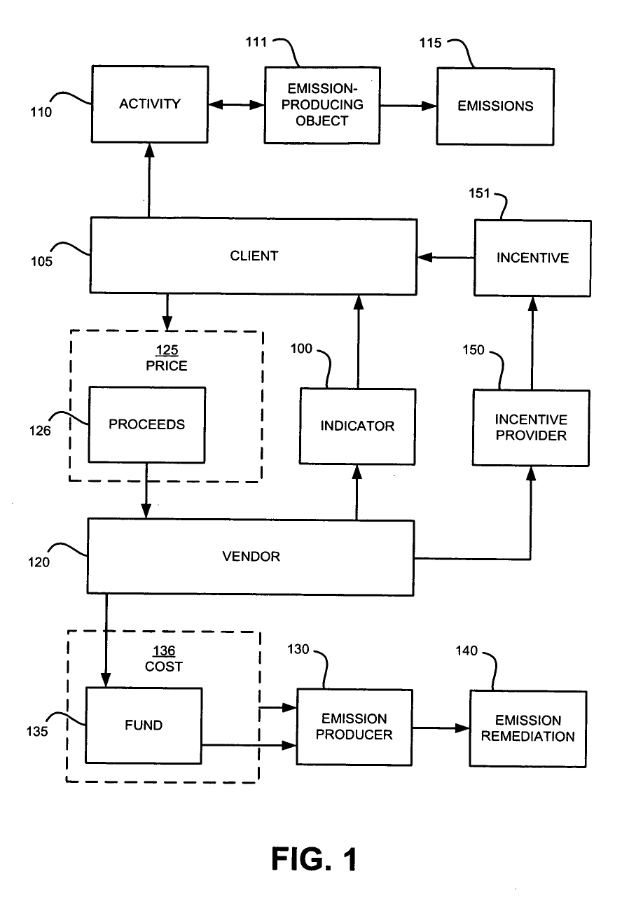

Referring to the drawings, in which like reference numerals indicate like elements, FIG. 1 is a diagram of relationships between entities, in accordance with herein described systems and methods. A client (e.g., purchaser, customer) 105 selects a desired activity 110. The activity 110 is associated with one or more emission-producing objects 111. An emission-producing object 111, when used in connection with the activity 110, generally produces a quantity of emissions 115. In an illustrative implementation, the emissions 115 include greenhouse gases, such as carbon dioxide and sulfur dioxide.

In the illustrative implementation, the activity 110 is further associated with an emission-producing object 111, such as a vehicle, e.g., an automobile, airplane, boat, truck, bus, passenger train, freight train, or the like. Such an activity 110 includes manufacturing the vehicle, operating the vehicle, being a passenger in the vehicle, purchasing an item that is shipped in the vehicle, shipping the item in a vehicle, and so forth.

In another illustrative implementation, exemplary activity 110 may be an event or services associated with an event (e.g., a concert, wedding, sporting event, conference, exhibition, trade show, or any other type of event), wherein the service or event is associated with any of numerous emission-producing objects 111 (e.g., vehicles driven to, from, or at the site of the event, vehicles used for shipment of products to and from the event, and the like).

In another illustrative implementation, activity 110 includes the manufacture, processing, or disposal of goods. Emission-producing objects 111 that may be associated with activity 110 include, e.g., a factory, plant, commercial facility, or the like, that produces emissions 115. Other illustrative activities 110 include building, maintaining, operating, owning, leasing or renting all or a portion of a home, commercial building, or other facility. Examples of relevant emission-producing objects 111 that may be associated with such activities 110 include without limitation, heating, ventilating, and air conditioning (HVAC) systems, refrigeration systems, appliances, and the like.

An exemplary vendor 120 may be a person, organization or entity that provides goods or services to clients 105 (including other vendors or intermediaries), e.g., a merchant, seller, supplier, retailer, wholesaler, lesser, franchisor, or service bureau. In an illustrative operation, the vendor 120 uses any of various means, including, but not limited to, electronic commerce and retail and commercial sales and marketing techniques to present to client 105 an opportunity to purchase an emission remediation indicator 100 having a price 125. In an illustrative purchase transaction, price 125 (such as, an amount of money or other tangible) is paid by client 105 to vendor 120 in exchange for remediation indicator 100.

In an illustrative implementation, client 105 purchases remediation indicator 100 based upon specific information regarding the selected activity 110 whose related emissions 115 the client 105 desires to remediate. In the illustrative implementation, client 105 enters information into a web site that is provided by or for vendor 120, or may consult information provided by the vendor 120. In the illustrative implementation, when marketing directly to the public, various means are used to attract the client 105 to the web site of vendor 120. Once at the site, in the illustrative implementation, client 105 enters information. Responsive to the inputted information, in the illustrative implementation, the vendor website operates to process the inputted information in an automated fashion. The same or similar techniques may be deployed by vendor 120 when marketing with, or through, an intermediary, such as a marketing partner.

In an illustrative operation, in the case of remediation of emissions 115 of an emission-producing object 111, such as an automobile, for example, client 105 could communicate various information to vendor 120 (e.g., by inputting information on vendor's 120 web site, not shown) including, but not limited to, the make and model of their specific car, as well as the miles they drive in a typical year. Such communication information may be used to calculate the total projected emissions 115 that result from selected activity 110 of client 105 (i.e., driving the automobile). This projection may be used as the basis for calculating price 125 for specific remediation indicator 100.

In an illustrative implementation, price 125 is calculated by vendor 120 based at least upon cost 136 of remediating a quantity of emissions 115 associated with the emission-related activity 110. Cost 136 is an actual, estimated, or projected cost. For example, price 125 for remediation indicator 100 may be proportional to the cost 136 of a specific contemplated project for emission remediation 140 to be undertaken by an emission producer 130. In the illustrative implementation, the quantity of emissions 115 is offset by a proportional share of the remediation 140.

In another illustrative implementation, price 125 is calculated based at least upon a product category associated with the emission-related activity 110. For example, where the emission-producing object 111 is an automobile, an exemplary product category is the type of automobile (e.g., make, model, and/or year), or a feature of the automobile (e.g., automatic transmission, number of cylinders, or hybrid engine).

In still another illustrative implementation, price 125 is calculated based at least upon a usage quantum associated with the emission-related activity 110. For example, where the activity 110 is airplane or automobile travel, an exemplary usage quantum may be a number of miles, a number of flights, or the like. In a further example, where the activity 110 is an event, the usage quantum may be a number of persons associated with the event (e.g., invited or confirmed guests).

In a further illustrative implementation, price 125 is calculated based at least upon a demographic category associated with the emission-related activity 110, such as information indicative of the number of persons likely to use a vehicle, the purposes for which the vehicle is used (e.g., commuting, deliveries, etc.), or the number of persons likely to travel to an event.

In the illustrative operation, vendor 120 receives proceeds 126 from price 125 paid by client 105. In an illustrative implementation, proceeds 126 represent a portion of price 125, such as a fixed percentage or a fixed amount. In another illustrative implementation, proceeds 126 are a net amount, for example, a portion of price 125 after subtracting expenses, costs, overhead, discounts, commissions, and/or other deductions.

In an illustrative implementation, vendor 120 allows one or more intermediaries to assist in the purchase transaction with client 105. In the illustrative implementation, such intermediaries include, but are not limited to, resellers, distributors, independent sales representatives, non-profit organizations, churches and synagogues, schools, or other third party organizations. Such intermediaries may offer remediation indicators 100 to clients 105, for example, as a way of raising funds for the intermediary, while demonstrating or rallying public support for efforts towards remediating polluting emissions, such as greenhouse gas emissions 115. Further examples of intermediaries include airlines, travel agents, and the like, who may offer an emission remediation indicator 100 to a client 105 in connection with the purchase by the client 105 of an emission-related activity 110, such as passage in a vehicle (e.g., purchase of an airline ticket). Such intermediaries are compensated or uncompensated.

Further, in an illustrative implementation, an incentive 151 is provided to client 105 for the purchase of remediation indicator 100. In an illustrative implementation, an incentive provider 150 preferably provides incentive 151 by agreement with vendor 120. Incentive 151 may include certification that the remediation has taken place. Such certification may be provided, for example, by an incentive provider 150 that is a third party certification organization (e.g., the Center for Resource Solutions and its Green-e Program). The incentive 151 may include, for example, a right to display a logo, trademark, service mark, or certification mark of the incentive provider 150 or of the vendor 120.

In another illustrative implementation, again using the driving example, incentive 151 provides a way for client 105 to gain special treatment, such as preferential parking spaces, or the ability to use high occupancy travel lanes on highways, or the like. Remediation indicator 100 may be used to provide to client 105 public recognition for remediation 140 that client 105 has performed, or to which client 105 has contributed.

In an illustrative implementation, incentive 151 may be the intangible benefit of community recognition resulting from client's 105 remediation activities (e.g., client 105 has taken steps to assure that, regardless which car he/she is driving, client 105 is not contributing to global warming).

In the illustrative operation, an emission producer 130 offers or otherwise agrees with vendor 120 to engage in an emission remediation activity 140 in exchange for payment into fund 135. Also, in the illustrative operation, vendor 120 may elect to aggregate at least a portion of proceeds 126 from a plurality of clients 105 into fund 135. Further, fund 135 may be used to cover at least a portion of cost 136 to emission producer 130 for engaging in remediation activity 140. Fund 135 may also be associated with at least a portion of the proceeds 126 from one or more emission remediation indicators 100.

In the illustrative operation, vendor 120 may work with a specific emission producer 130 (e.g., an energy producer or utility company) to develop and deploy an e-commerce application used in transacting remediation transactions in an effort to reduce pollution. In a further illustrative implementation, fund 135 may provide direct or incremental support to polluters, such as emission producer 130, encouraging a shift from current energy sources to less polluting sources, such as solar or wind power.

In a further illustrative operation, the fund 135 may be used to purchase remediation 140 from one or more emission producers 130, such as by using a trading exchange designed to trade in greenhouse gas emissions, such as the Chicago Climate Exchange (CCX), which offers Certified Emissions Instruments (CFIs). For example, a CFI is purchased in an amount corresponding to a reduction in emissions of 100 metric tons of carbon dioxide, and CFIs are purchased in bulk quantities, as may be desired.

Example of Emission Remediation

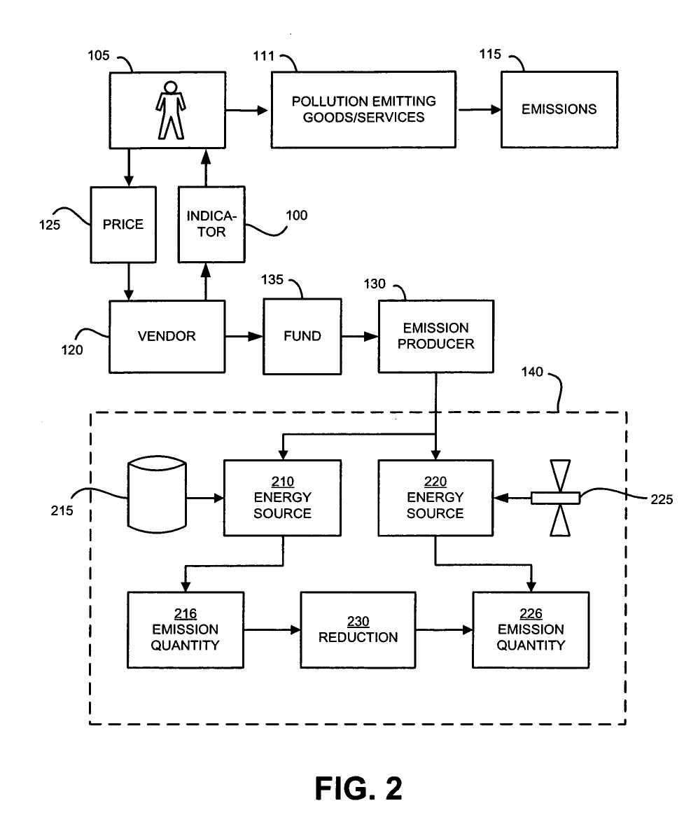

FIG. 2 depicts an exemplary implementation of an emission remediation 140. In an illustrative operation, a client 105 expects to drive an emission-producing object, such as car 111, approximately 12,500 miles per year. The client 105 communicates information to the vendor 120 that is sufficient to enable a determination that the car 111 will produce, for example, about 9,500 pounds of CO₂ emissions 115 per year, and to enable determination or calculation of a price 125 that is at least sufficient to provide a remediation activity 140 that would offset at least 9,500 pounds of CO₂ emissions 115.

In the illustrative operation, vendor 120 provides a remediation indicator 100 to the client 105 in exchange for the calculated price 125, and the vendor provides a fund 135 to an emission producer 130, causing the emission producer 130 to undertake the remediation 140. The emission producer 130 is, for example, an energy producer (e.g., a utility company) that generates or purchases power from a plurality of energy sources 210, 220, such as power plants, wind turbines, and the like. For example, a first illustrative energy source 210 uses fossil fuel 215, such as fuel oil, distillate fuel, natural gas, liquefied petroleum gases, coal, and the like, and produces a first quantity of emissions 216. A second illustrative energy source 220 generates power from a non-polluting or less-polluting source, such as one or more wind turbines 225, nuclear fusion, and the like, and produces a second quantity of emissions 226, which may be zero or greater than zero.

In return, the emission producer 130 agrees to provide remediation 140 by shifting usage from the more-polluting energy source 210 to the less-polluting energy source 220. For example, the emission producer 130 may accomplish such a usage shift by reducing its use of power generated from fossil fuel 215, and replacing it with power generated from wind turbines 225, in an amount sufficient to generate a reduction 230 in emissions. “Reduction” means achieving a change that causes the amount of polluting emission that is produced to be lower than that which was produced before implementation of the invention, or that is lower than the polluting emissions produced by an entity that is not part of the methods or system disclosed herein. In an illustrative operation, the reduction 230 is calculated to offset at least the exemplary 9,500 pounds of CO₂ emissions 115 produced by the car 111 of the client 105. In approximate figures, an illustrative shift of about 7,500 kilowatt-hours generated from fossil fuel 215 to about 7,500 kilowatt-hours generated from wind turbines 225 would result in a reduction in fossil fuel 215 usage of about twelve barrels of oil, which corresponds to reduction 230 in CO₂ emissions of about 9,500 pounds. This exemplary reduction 230 would offset the 9,500 pounds of CO₂ emissions 115 from client 105 driving 12,500 miles in car 111.

In another illustrative operation, fund 135 provides support for emission producer 130 to change its costs or charges to consumers for providing power from less-polluting energy sources, such as wind power 225. With such support, less-polluting sources of energy can achieve parity or slightly lower cost per kilowatt-hour. In the illustrative operation, fund 135 compensates emission producer 130 for the one-time changeover costs of switching from a more-polluting energy source 210 to a less-polluting energy source 220. It is appreciated, therefore, that in deploying the herein described systems and methods, a proportionately small amount of fund 135 can result in a large amount of emission remediation.

Illustrative Emission Remediation Indicator

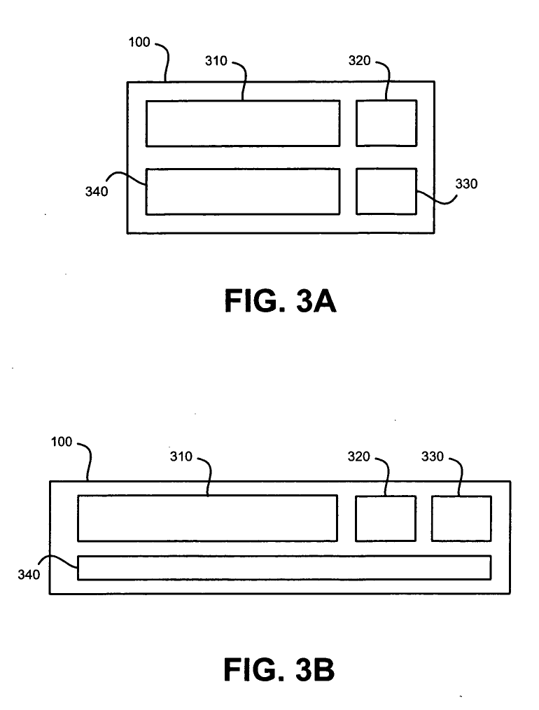

FIG. 3A shows an illustrative implementation of a remediation indicator 100 in the form of a rectangular card, placard, or plate (such as a marker which may be displayed on the front of an automobile if a license plate is not required by law in that location). FIG. 3B shows another illustrative implementation of remediation indicator 100 in the form of a bumper sticker, which may be applied to the rear of an automobile. However, in the present invention, client 105 may receive or display an emission remediation indicator 100 in any of numerous recognized forms.

In an illustrative operation, client 105 applies or affixes remediation indicator 100 to emission-producing object 111, or otherwise publicly displays remediation indicator 100, thereby displaying evidence that client 105 has caused an offsetting remediation 140 of the emissions 115 associated with specific activity 110. For example, layout areas 310-340 may be provided to display text, graphics, images, logos, trademarks, service marks, certification marks, trade names, product category information, expiration dates, advertisements, slogans, contact information, web site information, and the like. Any number of layout areas 310-340 may be provided on the remediation indicator 100, in a variety of configurations, to display information allowing the public to become aware of the efforts of the client 105 in remediating the emissions 115. In a further illustrative operation, any of the layout areas 310-340 may display coded or numeric information, such as a bar code, serial number, or the like, which are useful for verifying the authenticity of indicator 100 or the identity of client 105.

In an illustrative implementation, in the case of driving, remediation indicator 100 could be a bumper sticker as shown in FIG. 3B. In the case of an airline trip, remediation indicator 100 could be a luggage tag or a ticket jacket, whereas in the case of a wedding, remediation indicator 100 may be printed and included as part of a wedding invitation.

In the illustrative implementation, indicator 100 may be embodied in a sticker (such as a bumper sticker, window sticker, or the like), a plate (such as a license plate), a placard suitable for display, a logo (which may be printed on any of numerous objects), a medallion, a ticket (e.g., an airline ticket), a protective jacket (e.g., for carrying an airline ticket), an envelope, a tag (e.g., a luggage tag), a badge (e.g., a conference badge or other wearable display), a key-ring or fob, any of numerous types of card, and the like. Card-shaped embodiments of indicator 100 may include, but are not limited to, a credit card, a wallet card, an RFID card, and a smart card.

Remediation indicator 100 may also include electronic, optical, magnetic or other implementations, such as a data store, such as a magnetic stripe, a bar code, a semiconductor chip, or other forms of electronic, magnetic, optical data storage or the like. In an further illustrative implementation, remediation indicator 100 includes a transmitting device, such as an RFID transmitter. The data store and transmitting device are useful, for example, for verifying the authenticity of indicator 100 or the identity of client 105. The data store is also useful for storing data relating to a remediation credit, such as a remaining or refreshable amount of proceeds 126 or price 125, that may be applied to an ongoing or periodic activity 110.

Illustrative Emission Remediation Method

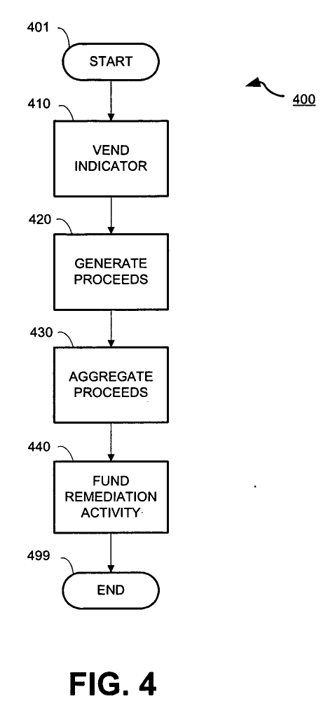

FIG. 4 is a flow chart of the processing performed for emission remediation according to an illustrative implementation of the herein described systems and methods. Processing 400 is herein described with reference to FIGS. 1-3B. As is shown in FIG. 4, processing begins at block 401, and the method proceeds to block 410. At block 410, an indicator 100 is vended. For example, the vendor 120 exchanges the indicator 100 for a price 125 received from a client 105. In an illustrative operation, the price 125 for the emission remediation indicator 100 is calculated using one or more bases. The bases include, for example, the cost 136 of remediating a quantity of polluting emissions 115 associated with an emission-related activity 110, a product category associated with the emission related activity 110, a usage quantum associated with the emission related activity 110, and a demographic category associated with the emission related activity 110. Processing then proceeds to block 420, where proceeds 126 are generated from the transaction represented in block 410. In an illustrative implementation, the proceeds 126 represent a portion of the price 125 set when vending the emission remediation indicator 100.

Processing continues to block 430, where proceeds 126 may be aggregated to fund a remediation activity 140 at block 440. In an illustrative implementation, remediation activity 140 may include a usage shift by the emission producer 130 from a first energy source 210 (e.g., a power plant using fossil fuel 215) associated with a first quantity of polluting emissions, such as greenhouse gas emissions 216 to a second energy source 220 (e.g., a wind plant using wind turbines 225) associated with a second quantity of polluting emissions, such as greenhouse gas emissions 226, wherein the second quantity 226 is lower than the first quantity 216. In the illustrative implementation, the remediation activity 140 comprises a reduction 230 in the quantities of polluting emissions, such as greenhouse gas emissions 216, 226 associated with an emission producer 130. Processing terminates at block 499.

While the foregoing specification has been described with regard to certain preferred embodiments, and many details have been set forth for the purpose of illustration, it will be apparent to those skilled in the art that the invention may be subject to various modifications and additional embodiments, and that certain of the details described herein can be varied considerably without departing from the spirit and scope of the invention. Such modifications, equivalent variations and additional embodiments are also intended to fall within the scope of the appended claims.

What is claimed is:

1. A method for remediating polluting emissions, comprising:
vending an emission remediation indicator associated with a polluting emission-related activity to generate proceeds; and
aggregating at least a portion of the proceeds to fund a polluting emission remediation activity.

2. The method of claim 1, wherein the emission remediation indicator is publicly displayable.

3. The method of claim 1, wherein the emission-related activity comprises polluting emission producing goods or services, energy-related operating, using, shipping, manufacturing or disposing of goods; or energy consuming services associated with an event; hosting an event; attending an event; heating; ventilating; air conditioning; or refrigerating, wherein energy production, consumption or use is associated with a polluting emission.

4. The method of claim 1, wherein the proceeds are derived from a price associated with vending of the emission remediation indicator.

5. The method of claim 1, further comprising:
calculating a price for the emission remediation indicator using one or more bases selected from the group comprising cost of remediating a quantity of emissions associated with the emission-related activity, a product category associated with the emission-related activity, a usage quantum associated with the emission-related activity, or a demographic category associated with the emission-related activity.

6. The method of claim 1, wherein the emission remediation indicator is displayable on an polluting emission-producing object associated with the polluting emission-related activity.

7. The method of claim 1, wherein the emission remediation indicator comprises an electronic, magnetic or optical component further comprising a transmitter or a data store, or both.

8. The method of claim 1, wherein the remediation activity comprises shifting usage by the emission producer from a first energy source associated with a first quantity of polluting emission to a second energy source associated with a second quantity of polluting emission, the second quantity being lower than the first quantity.

9. The method of claim 8, wherein the remediation activity further comprises reducing greenhouse gas emissions associated with an emission producer.

10. The method of claim 1, further comprising vending offsets on an exchange.

11. The method of claim 1, further comprising authorizing an intermediary party to vend the emission remediation indicator to one or more clients associated with the emission-related activity.

12. The method of claim 11, further comprising vending at least one product associated with the emission-related activity to the one or more clients.

13. The method of claim 12, wherein the product comprises at least a component of a polluting emission-producing good or service.

14. The method of claim 1, further comprising certifying that a price associated with the vended emission remediation indicator is greater than or equal to a cost for remediating a quantity of polluting emissions associated with the emission-related activity.

15. The method of claim 1, further comprising authorizing an incentive provider to associate a purchase by a client of the emission remediation indicator with a tangible or intangible incentive to the client.

16. The method of claim 15, wherein the incentive comprises a right, benefit, or cost-savings to the client, as compared with an individual without such right, benefit, or cost-saving incentive.

17. The method as recited in claim 1, further comprising vending a remediation credit associated with the emission remediation indicator.

18. The method as recited in claim 17, further comprising calculating the remediation credit based upon a fuel or energy purchase.

19. A method for remediating polluting emissions comprising:
providing an offer to a party to engage in a remediation activity;
providing funds to a party to realize the remediation activity, wherein the funds are generated in whole or in part from vending proceeds for vending one or more remediation indicators; and
monitoring the remediation activity.

20. The method of claim 19, wherein the remediation activity further comprises reducing greenhouse gas emissions associated with an emission producer.

21. The method of claim 19, wherein the emission producer is an energy provider.

22. The method of claim 19, wherein the remediation activity comprises shifting usage by the emission producer from a first energy source associated with a first quantity of polluting emissions to a second energy source associated with a second quantity of polluting emissions, the second quantity being lower than the first quantity.

23. A method for remediating polluting emissions comprising:
purchasing an emission remediation indicator associated with a polluting emission-related activity, wherein the remediation indicator is representative of one or more remediation programs having a protocol in which at least a portion of the proceeds from the purchase of remediation indicators is directed to a remediation activity; and
displaying the emission remediation indicator.

24. A system for remediating polluting emissions comprising:
emission remediation indicator associated with an emission-related activity, the indicator having a remediation price based at least upon a cost of remediating a quantity of emissions associated with the emission-related activity;
means for funding remediation activities, using at least a portion of proceeds derived from the remediation price, and
funds usable for funding remediation activities.

25. The system of claim 24, wherein the remediation activity further comprises reducing greenhouse gas emissions associated with an emission producer.

26. An emission remediation indicator displayable on an polluting emission-producing object associated with an polluting emission-related activity, the remediation indicator having a price based at least upon a cost of remediating a quantity of polluting emissions associated with the emission-related activity.
